(19) United States
(12) Patent Application Publication
(10) Pub. No.: US 2024/0428130 A1
(43) Pub. Date: Dec. 26, 2024

(54) REINFORCEMENT MACHINE LEARNING WITH MULTI-LEVEL AGENT SEARCH AND HYPERPARAMETER OPTIMIZATION

(71) Applicant: International Business Machines Corporation, Armonk, NY (US)

(72) Inventors: Long VU, Chappaqua, NY (US); Peter Daniel Kirchner, PUTNAM VALLEY, NY (US); Radu Marinescu, Dublin (IE); Dharmashankar Subramanian, RYE BROOK, NY (US); Nhan Huu Pham, Tarrytown, NY (US)

(21) Appl. No.: 18/341,398

(22) Filed: Jun. 26, 2023

(51) Int. Cl. G06N 20/00

(52) U.S. Cl. CPC G06N 20/00

(57) ABSTRACT

According to a present invention embodiment, a system identifies a plurality of configurations for machine learning models. Each configuration indicates a machine learning model and a corresponding technique to determine parameters for the machine learning model. The plurality of configurations are evaluated by training the machine learning model of the plurality of configurations according to the parameters determined by the corresponding technique. Performance of the machine learning models of the plurality of configurations is monitored, and resources used for evaluating at least one configuration are adjusted based on the performance of the machine learning model for the at least one configuration relative to the performance of the machine learning models of others of the plurality of configurations. Embodiments of the present invention further include a method and computer program product for training machine learning models in substantially the same manner described above.

### BACKGROUND

### 1. Technical Field

Present invention embodiments relate to machine learning, and more specifically, to reinforcement machine learning or reinforcement learning (RL) utilizing a multi-level agent search and hyperparameter optimization to identify a hyperparameter configuration and train an RL agent according to the identified hyperparameter configuration.

### 2. Discussion of the Related Art

Reinforcement learning (RL) agents are deployed in dynamic environments. Examples of RL agents include conversational agents or chatbots, online shopping software agents, spam filters, etc. Rather than being programmed to execute a series of tasks, these agents are configured to act autonomously in order to reach a desired goal. Reinforcement learning (RL) is based on interaction between an environment and an RL agent. A current state of the environment and reward is received, and an action is selected by the RL agent and performed. The environment transitions to a new state based on the action, and the reward associated with the transition is determined. Reinforcement learning (RL) determines a manner that maximizes the reward. In other words, the reinforcement learning (RL) rewards accurate decisions and penalizes for failures or incorrect decisions.

Agent search and hyperparameter optimization (HPO) is computationally expensive due to large search spaces with a growing number of candidate agents and tunable hyperparameters. In model-based reinforcement learning (RL), there may be many environments derived from the same input data set which further increases the size of the search space. Most existing agent search and hyperparameter optimization (HPO) approaches handle agent search and hyperparameter optimization (HPO) separately, thereby resulting in an inefficient, disjoint, and time-consuming search. In addition, performance of hyperparameter optimization (HPO) algorithms is often problem-specific. However, existing approaches use only one hyperparameter optimization (HPO) technique for all input scenarios.

### SUMMARY

According to one embodiment of the present invention, a system for training machine learning models comprises one or more memories, and at least one processor coupled to the one or more memories. The system identifies a plurality of configurations for the machine learning models. Each configuration indicates a machine learning model and a corresponding technique to determine parameters for the machine learning model. The plurality of configurations are evaluated by training the machine learning model of the plurality of configurations according to the parameters determined by the corresponding technique. Performance of the machine learning models of the plurality of configurations is monitored, and resources used for evaluating at least one configuration are adjusted based on the performance of the machine learning model for the at least one configuration relative to the performance of the machine learning models of others of the plurality of configurations. Embodiments of the present invention further include a method and computer program product for training machine learning models in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of machine learning training code for determining a hyperparameter configuration for training a reinforcement learning (RL) agent according to an embodiment of the present invention.

FIG. 3 is a procedural flowchart of a manner of performing a multi-level search and optimization of hyperparameters for training a reinforcement learning (RL) agent according to an embodiment of the present invention.

FIG. 4 is a procedural flowchart of a manner of identifying configurations providing greatest performance according to an embodiment of the present invention.

FIG. 5 is a procedural flowchart of a manner of evaluating configurations according to an embodiment of the present invention.

FIG. 6 is a table indicating performance of an embodiment of the present invention relative to a conventional technique in various environments.

### DETAILED DESCRIPTION

Present invention embodiments provide a multi-level pipeline (or configuration) search and optimization, which can run on a distributed infrastructure and scale to support a large search space of machine learning models, reinforcement learning (RL) agents, environments, and hyperparameter optimization (HPO) techniques.

An embodiment of the present invention determines an optimal hyperparameter configuration for training a reinforcement learning (RL) agent. The present invention embodiment decomposes a search space into sub-spaces and performs hyperparameter optimization (HPO) at each of a series of levels. The present invention embodiment enables bi-directional, continuous interaction between levels of the hyperparameter optimization (HPO) for resource allocation, coordination, and termination during the search. An outer level searches across different pipelines (or configurations) of various combinations of agents, environments, and HPO techniques, while an inner level searches across hyperparameters for a given pipeline (or configuration).

Present invention embodiments improve hyperparameter search thoroughness and efficiency through a multi-level search and optimization with inter-level interaction. Hyperparameter optimization (HPO) techniques represent a tunable parameter for different search spaces at each level. One or more outer levels identify pipelines (or configurations) that are evaluated by one or more inner levels. This allows the outer levels to monitor and adjust resources with respect to the performance of the inner levels, and the inner levels to store (or cache) an intermediate state of hyperparameter optimization (HPO), report performance back to the outer levels, and resume HPO for further optimization when requested by the outer levels.

Since present invention embodiments distribute decision-making across multiple levels with search space decomposition and enable hyperparameter optimization (HPO) at each level, more efficient scaling of the search is attained. Decisions at a given level require less communication and are simpler to make and, therefore, faster to achieve relative to more centralized approaches that produce bottlenecks when scaled.

A present invention embodiment automatically generates optimized machine learning models (e.g., reinforcement learning (RL) agents, etc.) through multi-level search and optimization. The present invention embodiment receives data sets, untrained machine learning models (e.g., RL agents, etc.), and hyperparameter optimization (HPO) techniques. The search and optimization include multiple levels and, at each level of the search hierarchy, the HPO technique is a tunable parameter. The present invention embodiment produces as output the top k (e.g., k≥1) pipelines. The produced pipelines may include optimized trained machine learning models (e.g., RL agents, etc.), hyperparameter configurations, optional associated environments, and optional best performing HPO techniques.

The present invention embodiment creates a search space encompassing pipelines. A pipeline includes a reinforcement learning (RL) agent, an environment, and a hyperparameter optimization (HPO) technique. A pipeline can also include transformers and estimators. In other words, the search space may be comprised of machine learning models (e.g., RL agents, etc.), hyperparameters of machine learning techniques and/or models, and HPO techniques. The environments are created from input data sets by using predictive machine learning models. An HPO technique searches for a next hyperparameter configuration (or values for a set of hyperparameters) of the machine learning models (e.g., RL agents, etc.), and performs training/evaluation on these configurations. An HPO technique minimizes/maximizes one or more objective metrics, such as mean return, std return, run-time, loss, etc.

The present invention embodiment performs a search across machine learning techniques in an outermost level, while one or more of the outer levels decompose the search space into sub-spaces, allocate resources (e.g., training epochs, timesteps, data size, etc.), and define a search sub-space for one or more inner levels. An inner level performs hyperparameter search and optimization on an assigned sub-space, model (or agent) training and evaluation, and reports the performance (e.g., loss, reward, etc.) back to the outer levels. The inner level terminates the search and optimization when the hyperparameter optimization (HPO) technique does not find better hyperparameter configurations for a pipeline that the inner level is optimizing.

The outer levels of the present invention embodiment determine a next resource allocation and search sub-space for the inner level upon receiving performance reports. Resources allocated by the outer levels and used by the inner level include training/evaluation iteration, timesteps, epochs, training/evaluation wall clock time period, number of hyperparameter configurations to be searched, etc. The outer level terminates the inner level when the on-going pipeline optimization does not improve performance metrics with respect to other pipelines in the outer level. Resulting hyperparameter configurations and trained optimized models (or agents) are aggregated, ranked, and provided as output.

The multi-level search and optimization of present invention embodiments may be applied to reinforcement and/or other types of machine learning, such as pipelines which include transformers and estimators.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

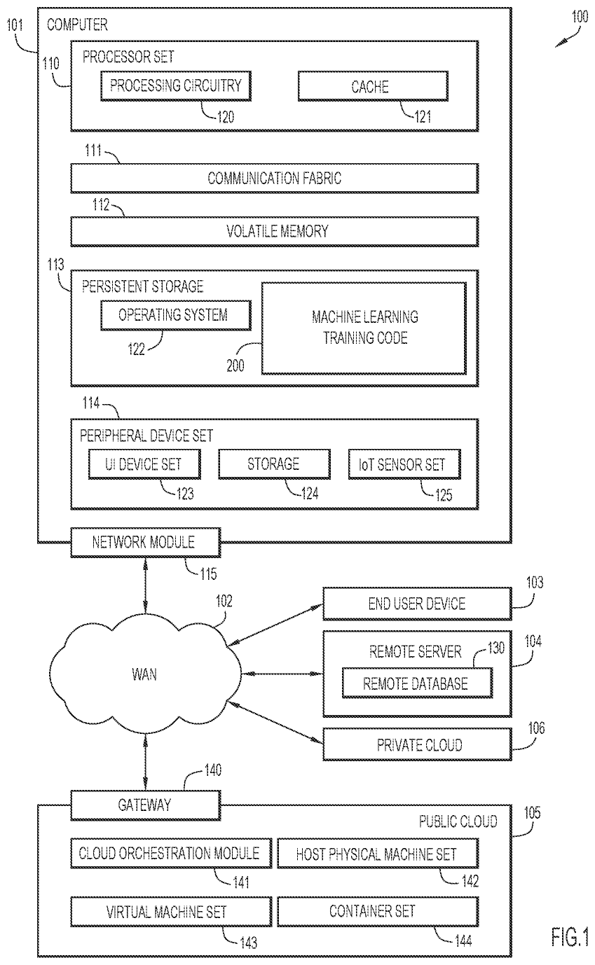

Referring to FIG. 1, computing environment 100 contains an example of an environment for the execution of at least some of the computer code involved in performing the inventive methods, such as machine learning training code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

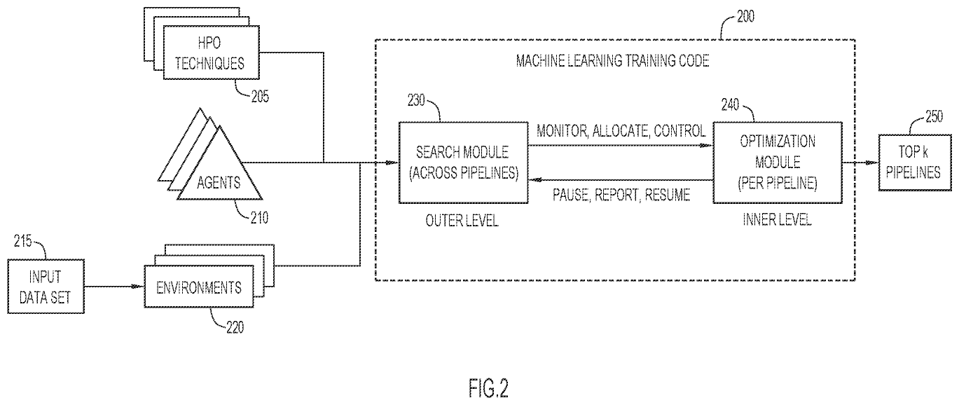

A block diagram of machine learning training code 200 is illustrated in FIG. 2. Initially, machine learning training code 200 receives hyperparameter optimization (HPO) techniques 205, reinforcement learning (RL) agents 210, and reinforcement learning (RL) environments 220. The machine learning training code may create RL environments 220 from input data set 215. The HPO techniques, RL agents and input data set 215/environments 220 may be configurable. By way of example, these items may include 4-5 HPO techniques 205, 10 RL agents 210, and 1-2 environments 220. However, any quantity of HPO techniques, RL agents, and environments may be used. Machine learning training code 200 produces the top k (e.g., k≥1) pipelines, where a pipeline (or configuration) includes a set of parameters and may be of the form <(agent, environment, HPO technique)>.

Machine learning training code 200 includes a search module 230 and an optimization module 240. Search module 230 performs an outer level pipeline search of a pipeline space defined by agents, environments, and hyperparameter optimization (HPO) techniques. In other words, the search module searches different combinations of agents, environments, and HPO techniques. The search space is decomposed into sub-spaces, and pipelines (e.g., specifying agents, environments, and HPO techniques) for performing hyperparameter optimizations (HPOs) are determined and launched (on the inner levels performed by optimization module 240). The search module uses a global view to monitor performance of running HPOs for pipelines, and to dynamically allocate more resources (e.g., epochs, timesteps, number of trials) to, and resume HPOs of, promising pipelines. In other words, the search module may provide more resources for HPOs of promising pipelines (e.g., showing greater performance of reinforcement learning (RL) agents relative to other pipelines), and terminate HPOs of pipelines showing less RL agent performance.

Optimization module 240 performs hyperparameter optimization (HPO) for pipelines. The optimization module performs a hyperparameter search within a given sub-space, and trains and evaluates the reinforcement learning (RL) agent of a corresponding pipeline. A state of the search is stored (or cached), and the optimization module may pause and report intermediate performance of the RL agent to search module 230 (performing the outer level). Optimization module 240 may resume a search (of an inner level) upon being notified by search module 230 (performing an outer level), and may find the best hyperparameter configurations (or values for sets of hyperparameters) within the sub-space. The search module produces the top k (e.g., k≥1) pipelines 250 (e.g., specifying agents, environments, and HPO techniques) based on evaluation by optimization module 240.

The search and optimization according to an embodiment of the present invention may include any quantity of outer and inner levels. For example, a search may be performed over hierarchically partitioned spaces. In this example case, a first level (or outermost level) may select a hyperparameter optimization (HPO) technique species (e.g., proximal policy optimization (PPO), advantage actor critic (a2c), etc.). A second (outer) level may select an agent/library implementation (e.g., stable-baselines PPO, stable-baselines A2C, etc.). A third (outer) level may select level values for implementation-independent hyperparameters. An inner level may select values for remaining hyperparameters (e.g., implementation and/or data-size dependent hyperparameters, etc.). The HPO technique is a tunable hyperparameter at each level in the search hierarchy.

Successive refinement and evaluation of selections reduces redundant exploration. The combination of search space decomposition, intermediate search outcome aggregation, and resource allocation on-the-fly expedites or speeds up the search. Early exploration can be performed using smaller portions of the data, with the outcomes still helpful in later phases using all or most of the data.

Scores and parameters for completed trials with a common reinforcement learning (RL) agent and environment are available to the hyperparameter optimization (HPO) techniques for initialization or update, when the HPO technique can use them. The multi-level search and optimization of a present invention embodiment may also be applied to other types of machine learning, such as pipelines (e.g., sci-kit learn (sklearn), etc.) which include transformers and estimators.

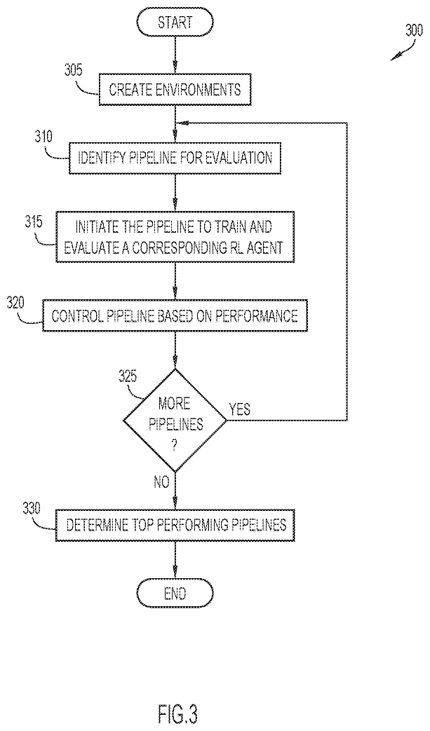

A method 300 of performing a multi-level search and optimization of hyperparameters for training a reinforcement learning (RL) agent (e.g., via computer 101 and machine learning training code 200) according to an embodiment of the present invention is illustrated in FIG. 3. Basically, an outer level of the multi-level search and optimization searches across different pipelines (or configurations) of various combinations of agents, environments, and HPO techniques, while an inner level searches across hyperparameters for a given pipeline (or configuration). Initially, reinforcement learning (RL) environments (e.g., for a search space, etc.) are created at operation 305. The environments may be created based on an input data set. RL agents may expect certain types of environments (e.g., compatible with OpenAI Gym or other tools, etc.). These environments can be created with machine learning predictive models via any conventional or other techniques. Since different predictive models can be built from a single input data set, multiple environments can be created from one input data set. The selection of an environment becomes a tunable parameter in pipeline creation.

A pipeline according to an embodiment of the present invention preferably includes a reinforcement learning (RL) agent, an environment, and a hyperparameter optimization (HPO) technique. There are existing HPO techniques (e.g., Hyperopt, BOHB, Blend, etc.), where each technique can work well with a certain search space. However, previous approaches used only one HPO technique to find the best hyperparameter configuration for all types of search spaces, which is ineffective. Accordingly, present invention embodiments include the HPO technique as one of the tunable parameters in the search space. This enables the inner level of present invention embodiments to evaluate different HPO techniques in order to find the best one for a given scenario.

Search module 230 identifies a pipeline (or configuration) for evaluation by optimization module 240 at operation 310. An inference model may be used to identify a next pipeline (e.g., a reinforcement learning (RL) agent, an environment, and a hyperparameter optimization (HPO) technique). Evaluation of the pipeline is initiated at operation 315 to evaluate a corresponding RL agent with respect to the environment and HPO technique. Search module 230 determines initial resources for optimization module 240 (e.g., an inner level) to perform RL training of the RL agent (e.g., epochs, timesteps, etc.). The search module forwards the pipeline to the optimization module (e.g., inner level) for evaluation.

Optimization module 240 performs evaluation of the pipeline for hyperparameter optimization (HPO). The optimization module performs a hyperparameter search within a given sub-space (e.g., for values of a set of hyperparameters, etc.), and trains and evaluates the reinforcement learning (RL) agent. A state of the search is stored or cached, and the optimization module may pause and report intermediate performance to search module 230. Search module 230 monitors performance of the reinforcement learning (RL) agent of the pipeline being evaluated, and controls resources used for evaluation of the pipeline at operation 320. The search module may resume and dynamically allocate more resources (e.g., epochs, timesteps, number of trials, etc.) for pipelines with RL agents having greater performance relative to RL agents of other pipelines. The search module may initiate evaluation of pipelines in parallel and/or periodically evaluate performance of RL agents of pipelines (e.g., after receiving a certain number of performance reports, after a predetermined or configurable time interval, etc.). Thus, optimization module 240 may resume a hyperparameter search for a pipeline upon being notified by search module 230.

The process is repeated from operation 310 until the pipelines have been processed as determined at operation 325. Once the pipelines are processed, search module 230 produces the top k (e.g., k≥1) pipelines at operation 330 based on evaluation by optimization module 240.

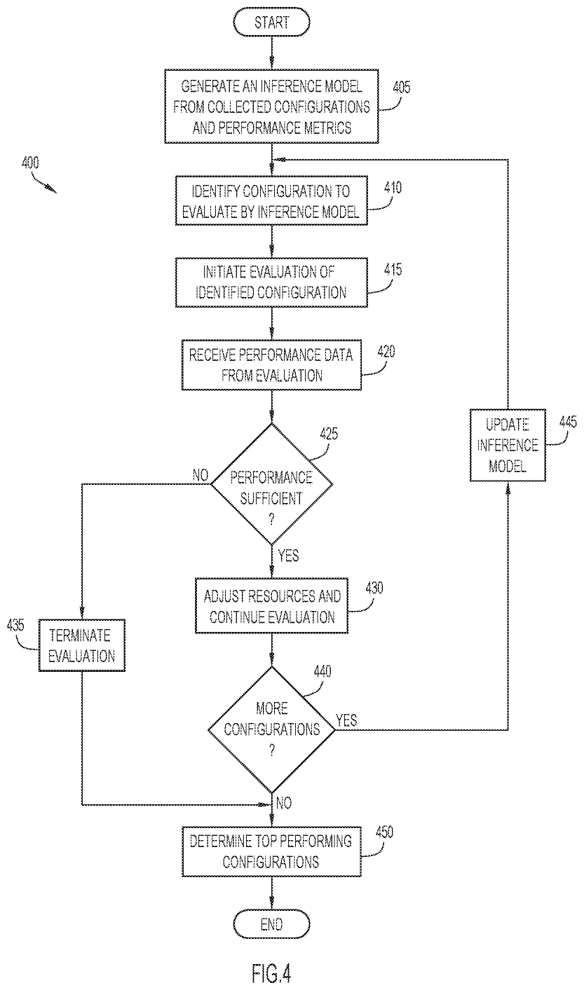

A method 400 of identifying configurations providing greatest performance (e.g., via search module 230 and computer 101, etc.) according to an embodiment of the present invention is illustrated in FIG. 4. The search module receives a search space of pipelines (or configurations) (e.g., multiple RL agents, multiple environments, multiple HPO algorithms), and produces the top k (e.g., k≥1) pipelines. The produced pipelines each include an RL agent, an environment, and a hyperparameter optimization (HPO) technique used.

Search module 230 generates an inference model at operation 405. The inference model may be implemented by any conventional or other machine learning models (e.g., a predictive machine learning regression model, Random Forest, k-nearest neighbor (KNN), neural network, etc.). The inference model receives pipelines (or configurations) as input (e.g., reinforcement learning (RL) agent, environment and hyperparameter optimization technique), and produces a prediction on performance metrics of the RL agent (e.g., accuracy, receiver operator characteristic (ROC) curves, etc.). The inference model may be generated/trained based on a collection of configurations and associated performance metrics of corresponding RL agents (e.g., accuracy, run-time, etc.).

The inference model of search module 230 identifies a pipeline (or configuration) for evaluation at operation 410. The identified pipeline includes a reinforcement learning (RL) agent, an environment, and a hyperparameter optimization (HPO) technique. The search module initiates evaluation of the identified configuration (by optimization module 240) at operation 415. For example, the search module calculates initial resources (e.g., epochs, timesteps, etc.) for optimization module 240 (e.g., inner level) to train the RL agent for the pipeline, and forwards the pipeline to the optimization module (e.g., inner level) for evaluation. In a distributed implementation (e.g., using Ray Tune, etc.), concurrent distributed trials may be launched on remote worker processes (e.g., on a local or remote machine). Each trial handles one separate individual pipeline. The search module may also specify the search sub-space for each pipeline.

Optimization module 240 performs evaluation of the pipeline for hyperparameter optimization (HPO). The optimization module performs a hyperparameter search (e.g., for values of a set of hyperparameters within the search sub-space), and trains and evaluates the reinforcement learning (RL) agent. The hyperparameters may include any quantity of hyperparameters, and pertain to training parameters of the RL agent and/or to parameters of the machine learning model of the RL agent. A state of the search is stored or cached, and the optimization module may pause and report intermediate performance of the RL agent to search module 230. The search module receives the performance report (e.g., reward, loss, etc.) at operation 420, and analyzes the performance of the RL agent relative to performance of RL agents of other pipelines at operation 425. This may be accomplished by a pairwise comparison of the pipeline to other pipelines, or by a prediction model (e.g., any conventional or other machine learning model, etc.) based on time series data of the performance. The search module may initiate evaluation of pipelines in parallel and/or periodically evaluate performance of RL agents of pipelines (e.g., after receiving a certain number of performance reports, after a predetermined or configurable time interval, etc.). When the performance of the pipeline is worse than performance of other pipelines (e.g., worse than a threshold quantity of other pipelines, etc.), the evaluation is terminated at operation 435. For example, in a distributed implementation (e.g., using Ray Tune, etc.), the termination of ineffective pipelines may be accomplished by an Asynchronous HyperBand scheduler.

When the performance of the pipeline is sufficient with respect to the other pipelines (e.g., greater than a threshold quantity of other pipelines, etc.) as determined at operation 425, the resources for optimization module 240 to evaluate the pipeline are adjusted to continue the evaluation at operation 430. For example, search module 230 may examine the states of on-going pipeline evaluations and determine an amount of additional resources to allocate for the optimization module to further optimize a pipeline. The search module notifies the optimization module of the additional resources for the pipeline optimization. For example, in a distributed implementation (e.g., using Ray Tune, etc.), the notification of further pipeline optimization may be accomplished by reusing the same trial object. Allocated resources for optimization module 240 may include a number of additional hyperparameter configurations to be searched, training/evaluation iterations, training/evaluation epochs, training/evaluation timesteps, etc.

When additional pipelines (or configurations) are present as determined at operation 440, the internal database states for the pipelines are updated, and the inference model is updated (or retrained) for the next search step at operation 445. The process is repeated from operation 410 until the pipelines (or configurations) (of the input search space) have been processed as determined at operation 440. Once the pipelines (or configurations) have been processed, search module 230 determines (and/or provides or displays) the top k (e.g., k≥1) pipelines at operation 450. The produced pipelines each include an RL agent, an environment, and a hyperparameter optimization (HPO) technique used. Typically, the environment of a produced pipeline has been previously created, while the RL agent preferably includes an RL agent trained for the environment according to the HPO technique (and corresponding hyperparameters). Alternatively, the RL agent of a produced pipeline may be trained for the environment based on the HPO technique (and corresponding hyperparameters).

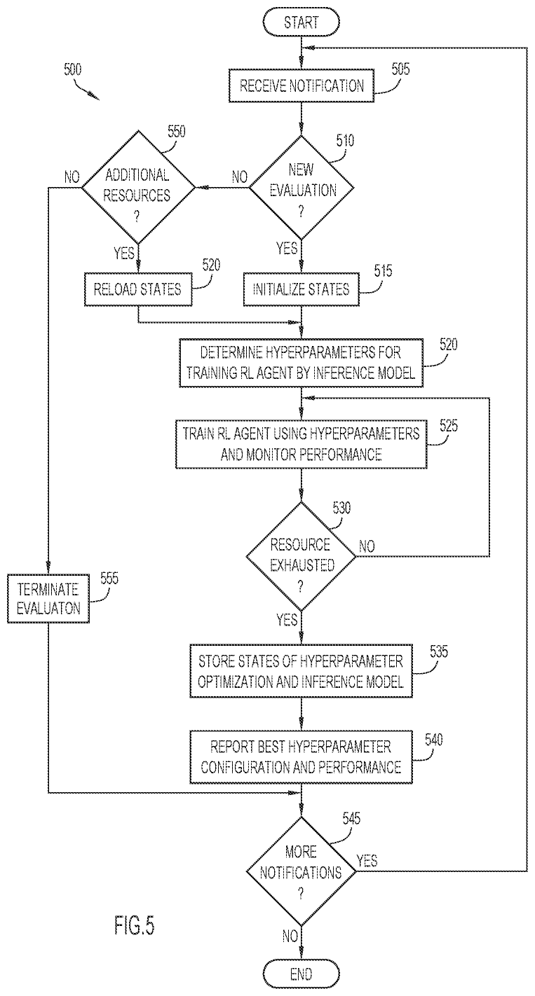

A method 500 of evaluating configurations (e.g., via optimization module 240 and computer 101, etc.) according to an embodiment of the present invention is illustrated in FIG. 5. Initially, optimization module 240 receives a reinforcement learning (RL) agent, an environment, a hyperparameter optimization (HPO) technique, assigned resources by search module 230, and a search sub-space for HPO, and determines the best hyperparameter configurations of the input RL agent (e.g., values of a set of hyperparameters, etc.) and corresponding performance metrics (e.g., mean returns, std returns, run-times, etc.).

Optimization module 240 performs search and evaluation functionality. The search functionality collects configurations (or pipelines) and associated performance metrics (e.g., accuracy, run-time, etc.), and may store these in a database (e.g., database 130). An inference model is generated/trained based on the configurations and performance metrics to predict accuracy and run-time of a reinforcement learning (RL) agent. The inference model may be any conventional or other machine learning model (e.g., predictive machine learning regression model, Random Forest, k-nearest neighbor (KNN), neural network, etc.). The inference model determines a next hyperparameter configuration (e.g., values of a set of hyperparameters, etc.) to evaluate. The hyperparameters may be of any quantity, and pertain to training parameters of the RL agent and/or to parameters of the machine learning model of the RL agent. For example, the set of hyperparameters may include 5 dimensions or parameters that are initialized with random values. The values of these hyperparameters may be successively determined over time and used to generate, train and/or update the inference model.

Input for the search functionality includes a search space (e.g., a dictionary for Python, etc.) which can be modified by search module 230. Thus, by defining this search space with respect to dimensions and ranges (e.g., specific hyperparameters and value ranges, etc.), the search module (e.g., outer level) controls behavior of the hyperparameter optimization (HPO) of the optimization module (e.g., inner level).

The evaluation functionality initializes, trains, and evaluates a model of the reinforcement learning (RL) agent when a new pipeline (or configuration) is received from the search functionality. The evaluation functionality is computationally expensive. However, multi-fidelity techniques can be used to improve running time of RL agent training and evaluation with gradual resource allocation with data set subsets, feature subsets, and lower number of epochs. Resources used by the evaluation functionality can be specified by search module 230 (e.g., outer level). Accordingly, the search module (e.g., outer level) can prolong or terminate the hyperparameter optimization (HPO) by optimization module 240 (e.g., inner level) by specifying the resources (e.g., epochs, timesteps, number of hyperparameter configurations to be searched).

In particular, optimization module 240 receives a notification from search module 230 at operation 505. The notification may indicate a new pipeline (or configuration) for evaluation, or may indicate additional resources or termination for a prior pipeline (or configuration). When the notification indicates a new pipeline (or configuration) as determined at operation 510, the optimization module initializes states for the new pipeline (or configuration) at operation 515. When the notification indicates additional resources as determined at operations 510 and 550, optimization module 240 reloads internal states of the hyperparameter optimization technique (HPO) and inference model (e.g., from cache or other storage) to resume the evaluation at operation 520. When the notification indicates termination of a prior pipeline (or configuration) as determined at operations 510 and 550 (e.g., does not indicate a new pipeline (or configuration) or additional resources), optimization module 240 terminates evaluation of the prior pipeline (or configuration) at operation 555.

After initializing or reloading states at operations 515, 520 (for a new pipeline (or configuration) or additional resources), the inference model of the search functionality of optimization module 240 determines a next hyperparameter configuration (e.g., values for a set of hyperparameters) for the reinforcement learning (RL) agent of the indicated pipeline (or configuration) at operation 520. In a distributed implementation (e.g., using Ray Tune, etc.), concurrent distributed trials with different hyperparameter configurations (e.g., values for sets of hyperparameters) may be launched on remote worker processes (e.g., on local or remote machines) for evaluation, where each trial handles one hyperparameter configuration (e.g., values for a set of hyperparameters). The hyperparameters may be of any quantity, and pertain to training parameters of the RL agent and/or to parameters of the machine learning model of the RL agent. The pipeline optimization or evaluation may terminate by itself when the search and evaluation do not result in better configurations. By way of example, in a distributed implementation (e.g., using Ray Tune, etc.), the termination can be accomplished by an Asynchronous HyperBand scheduler.

The evaluation functionality of optimization module 240 initializes the reinforcement learning (RL) agent with the determined hyperparameter configuration (e.g., values for the set of hyperparameters), trains and evaluates the initialized RL agent in the environment specified in the pipeline, and monitors the performance of the RL agent in the specified environment at operation 525. The internal states of the hyperparameter optimization (HPO) technique are updated, and the inference model is retrained for a next search. The RL agent is trained and monitored at operation 525 until the assigned resources (from search module 230) for the evaluation are exhausted as determined at operation 530.

Once the resources are exhausted, the intermediate states of the hyperparameter optimization (HPO) and the inference model are stored (or cached) at operation 535. Optimization module 240 reports the best hyperparameter configuration and performance metrics (e.g., list of mean returns, list of std returns, list of run-times) back to search module 230 (e.g., outer level) at operation 540. Optimization module 240 waits for a notification from search module 230 (e.g., outer level) (e.g., termination or resume optimization of the same pipeline, etc.). The above process repeats from operation 505 until no further additional notifications are to be received as determined at operation 545. The communication between search module 230 and optimization model 240 (e.g., notifications, performance reports, etc.) may be accomplished using any conventional or other messaging protocol (e.g., sending messages between the search and optimization modules, etc.).

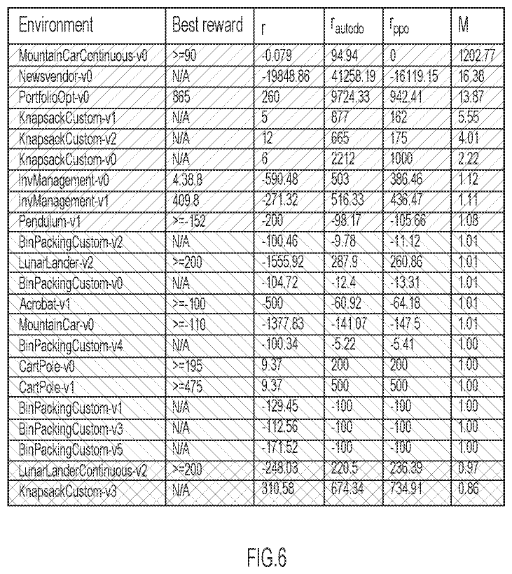

An embodiment of the present invention is compared to conventional proximal policy optimization (PPO) techniques across several environments. A comparison metric, M, may be expressed as:

$$M = ( r - {r}_{start} ) / ( {r}_{PPO} - {r}_{start} ) ;$$

where rₛₜₐᵣₜ is an initial reward, r_{PPO} is a final reward of an agent trained by a PPO technique, and r is a final reward of an agent trained by an embodiment of the present invention. A value of M greater than or equal to one (M≥1) indicates the present invention embodiment performs as well as or better than the PPO technique in a corresponding environment. As illustrated in FIG. 6, the present invention embodiment outperforms or matches the PPO technique (e.g., M≥1) in an overwhelming majority of environments.

Present invention embodiments may be applied to reinforcement and other types of machine learning. For example, present invention embodiments may utilize pipelines indicating a machine learning model, a training data set, and a machine learning technique (e.g., hyperparameter optimization (HPO) technique, etc.), where the multi-level search and optimization may be performed in substantially the same manner described above. By way of example, the pipelines may include transformers and estimators.

Accordingly, present invention embodiments provide several technical advantages. For example, present invention embodiments enable faster training of reinforcement learning (RL) agents or other machine learning models, thereby improving computer performance by utilizing reduced processing and storage. Further, the present invention embodiments conserve processing and storage by using reduced search spaces and focusing on trials with promising results. In other words, present invention embodiments focus on promising trials and terminate less promising trials to produce trained models faster and with reduced processing.

It will be appreciated that the embodiments described above and illustrated in the drawings represent only a few of the many ways of implementing embodiments for reinforcement machine learning with multi-level agent search and hyperparameter optimization.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., machine learning training code 200, search module 230, optimization module 240, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information (e.g., hyperparameter optimization (HPO) states, notifications, performance metrics, etc.). The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information.

The present invention embodiments are not limited to the specific tasks or algorithms described above, but may be utilized for training any machine learning models.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of training machine learning models comprising:
identifying, via at least one processor, a plurality of configurations for the machine learning models, wherein each configuration indicates a machine learning model and a corresponding technique to determine parameters for the machine learning model;
evaluating, via the at least one processor, the plurality of configurations by training the machine learning model of the plurality of configurations according to the parameters determined by the corresponding technique;
monitoring, via the at least one processor, performance of the machine learning models of the plurality of configurations; and
adjusting, via the at least one processor, resources used for evaluating at least one configuration based on the performance of the machine learning model for the at least one configuration relative to the performance of the machine learning models of others of the plurality of configurations.

2. The method of claim 1, wherein the machine learning model of one or more configurations includes a reinforcement learning agent and the corresponding technique includes a hyperparameter optimization technique, and wherein the one or more configurations further indicate an environment for the reinforcement learning agent.

3. The method of claim 1, wherein adjusting the resources for evaluating the at least one configuration comprises:
terminating the evaluation of the at least one configuration based on the at least one configuration having a machine learning model with lesser performance relative to the performance of the machine learning models of others of the plurality of configurations.

4. The method of claim 1, wherein monitoring performance of the machine learning models comprises:
pausing evaluation of the plurality of configurations at an intermediate portion of the evaluation; and
producing a report for the performance of the machine learning models of the plurality configurations.

5. The method of claim 4, wherein adjusting the resources for evaluating the at least one configuration comprises:
allocating additional resources to resume the evaluation of the at least one configuration based on the at least one configuration having a machine learning model with greater performance relative to the performance of the machine learning models of others of the plurality of configurations.

6. The method of claim 1, further comprising:
identifying one or more configurations with a machine learning model providing greater performance relative to performance of machine learning models of others of the plurality of configurations.

7. The method of claim 1, further comprising:
controlling, via the at least one processor, the evaluation of a configuration based on defining a search space for the evaluation of the configuration comprising a set of machine learning hyperparameters and value ranges for the set of machine learning hyperparameters.

8. A system for training machine learning models comprising:
one or more memories; and
at least one processor coupled to the one or more memories, and configured to:
identify a plurality of configurations for the machine learning models, wherein each configuration indicates a machine learning model and a corresponding technique to determine parameters for the machine learning model;
evaluate the plurality of configurations by training the machine learning model of the plurality of configurations according to the parameters determined by the corresponding technique;
monitor performance of the machine learning models of the plurality of configurations; and
adjust resources used for evaluating at least one configuration based on the performance of the machine learning model for the at least one configuration relative to the performance of the machine learning models of others of the plurality of configurations.

9. The system of claim 8, wherein the machine learning model of one or more configurations includes a reinforcement learning agent and the corresponding technique includes a hyperparameter optimization technique, and wherein the one or more configurations further indicate an environment for the reinforcement learning agent.

10. The system of claim 8, wherein monitoring performance of the machine learning models comprises:
pausing evaluation of the plurality of configurations at an intermediate portion of the evaluation; and
producing a report for the performance of the machine learning models of the plurality configurations.

11. The system of claim 10, wherein adjusting the resources for evaluating the at least one configuration comprises:
allocating additional resources to resume the evaluation of the at least one configuration based on the at least one configuration having a machine learning model with greater performance relative to the performance of the machine learning models of others of the plurality of configurations.

12. The system of claim 8, wherein the at least one processor is further configured to:
identify one or more configurations with a machine learning model providing greater performance relative to performance of machine learning models of others of the plurality of configurations.

13. The system of claim 8, wherein the at least one processor is further configured to:
control the evaluation of a configuration based on defining a search space for the evaluation of the configuration comprising a set of machine learning hyperparameters and value ranges for the set of machine learning hyperparameters.

14. A computer program product for training machine learning models, the computer program product comprising one or more computer readable storage media having program instructions collectively stored on the one or more computer readable storage media, the program instructions executable by at least one processor to cause the at least one processor to:
identify a plurality of configurations for the machine learning models, wherein each configuration indicates a machine learning model and a corresponding technique to determine parameters for the machine learning model;
evaluate the plurality of configurations by training the machine learning model of the plurality of configurations according to the parameters determined by the corresponding technique;
monitor performance of the machine learning models of the plurality of configurations; and
adjust resources used for evaluating at least one configuration based on the performance of the machine learning model for the at least one configuration relative to the performance of the machine learning models of others of the plurality of configurations.

15. The computer program product of claim 14, wherein the machine learning model of one or more configurations includes a reinforcement learning agent and the corresponding technique includes a hyperparameter optimization technique, and wherein the one or more configurations further indicate an environment for the reinforcement learning agent.

16. The computer program product of claim 14, wherein adjusting the resources for evaluating the at least one configuration comprises:
terminating the evaluation of the at least one configuration based on the at least one configuration having a machine learning model with lesser performance relative to the performance of the machine learning models of others of the plurality of configurations.

17. The computer program product of claim 14, wherein monitoring performance of the machine learning models comprises:
pausing evaluation of the plurality of configurations at an intermediate portion of the evaluation; and
producing a report for the performance of the machine learning models of the plurality configurations.

18. The computer program product of claim 17, wherein adjusting the resources for evaluating the at least one configuration comprises:
allocating additional resources to resume the evaluation of the at least one configuration based on the at least one configuration having a machine learning model with greater performance relative to the performance of the machine learning models of others of the plurality of configurations.

19. The computer program product of claim 14, wherein the program instructions further cause the at least one processor to:
identify one or more configurations with a machine learning model providing greater performance relative to performance of machine learning models of others of the plurality of configurations.

20. The computer program product of claim 14, wherein the program instructions further cause the at least one processor to:
control the evaluation of a configuration based on defining a search space for the evaluation of the configuration comprising a set of machine learning hyperparameters and value ranges for the set of machine learning hyperparameters.
